(19) United States
(12) Patent Application Publication
(10) Pub. No.: US 2013/0218482 A1
(43) Pub. Date: Aug. 22, 2013

(54) WIRELESS SENSING SYSTEM

(71) Applicants: Pai-Hsiang CHOU, Taipei City (TW); An-Ping Wang, Hsinchu City (TW); Guo-Huei Chang, Hsinchu City (TW)

(72) Inventors: Pai-Hsiang CHOU, Taipei City (TW); An-Ping Wang, Hsinchu City (TW); Guo-Huei Chang, Hsinchu City (TW)

(21) Appl. No.: 13/530,742

(22) Filed: Jun. 22, 2012

(30) Foreign Application Priority Data
Feb. 17, 2012 (TW) 101105296

(51) Int. Cl. G06F 19/00; G01N 21/00

(52) U.S. Cl. 702/32; 356/72

(57) ABSTRACT

A wireless sensing system includes a sensing device, a transmission device, and a micro-processing device. The sensing device senses a physical quantity or a chemical quantity of peripheral environment and generates a sensing signal. The transmission device coupled to the sensing device performs data transmission with an external network through a radio-frequency signal. The micro-processing device generates a corresponding operation according to the sensing signal or the radio-frequency signal. After the system is initialized, the micro-processing device and the transmission device are in a sleep state. When the sensing signal is larger than a threshold value, the sensing device wakes the micro-processing device and the transmission device up.

This application claims priority of No. 101105296 filed in Taiwan R.O.C. on Feb. 17, 2012 under 35 USC 119, the entire content of which is hereby incorporated by reference.

### BACKGROUND OF THE INVENTION

1. Field of the Invention

The invention relates to a wireless sensing system, and more particularly to a wireless sensing system capable of saving power and integrating transmission interfaces.

2. Related Art

The application scopes of wireless sensing systems may include environment monitoring, military uses, medical monitoring, industry monitoring, meter control, commercial building automation control, family daily-life monitoring, consumer electronic goods, and the like. So, the wireless sensing system has huge business opportunities.

If the wireless sensing system is located in dangerous areas, such as a volcanic area, a nuclear power plant and the like, and if the wireless sensing system is too power-consumptive, the battery of the wireless sensing system is rapidly used up and has to be replaced with a new one manually. It can be costly, inconvenient, if not dangerous for the repairer.

### SUMMARY OF THE INVENTION

An object of the invention is to provide a wireless sensing system capable of saving the power.

Another object of the invention is to provide a wireless sensing system capable of integrating transmission interfaces.

An embodiment of the invention provides a wireless sensing system including a sensing device, a transmission device, and a micro-processing device. The sensing device senses a physical quantity or a chemical quantity of peripheral environment and generates a sensing signal. The transmission device is coupled to the micro-processing device and performs data transmission with an external network through a radio-frequency signal. The micro-processing device generates a corresponding operation according to the sensing signal or the radio-frequency signal. After the system is initialized, the micro-processing device and the transmission device are in a sleep state. When the sensing signal is larger than a threshold value, the sensing device wakes up the micro-processing device and the transmission device.

An embodiment of the invention provides a method of operating a wireless sensing system. The method includes: initializing the system; setting a threshold value of a triaxial acceleration-sensing device or an analog-to-digital conversion device; setting a parameter of the triaxial acceleration-sensing device or an optical-sensing device; letting the system enter a sleep state; and judging whether an acceleration value of one of an X axis, a Y axis and a Z axis of the triaxial acceleration-sensing device is conjunctively or disjunctively larger than the threshold value, or whether a luminance value of an light sensed from environment by the optical sensing device is larger than the threshold value, and waking the system up and transmitting a radio-frequency signal to make the system perform corresponding adjustment when the acceleration value or the luminance value is larger than the threshold value.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below and the accompanying drawings that are given by way of illustration only, and thus are not limitative of the present invention.

FIG. 1 is a schematic illustration showing a wireless sensing system according to an embodiment of the invention.

FIG. 2A is a schematic illustration showing a wireless sensing system according to an embodiment of the invention.

FIG. 2B is a schematic illustration showing a wireless sensing system according to an embodiment of the invention.

FIG. 3 is a flowchart showing an operation method of a wireless sensing system according to an embodiment of the invention.

### DETAILED DESCRIPTION OF THE INVENTION

The present invention will be apparent from the following detailed description, which proceeds with references to the accompanying drawings, wherein the same references relate to the same elements.

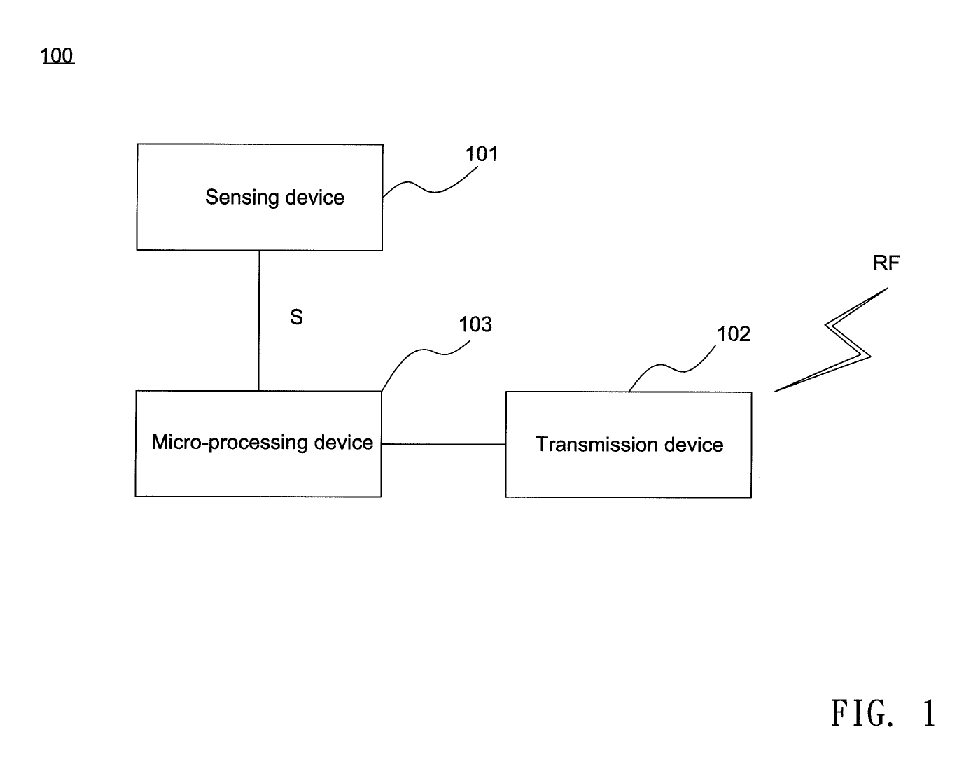

FIG. 1 is a schematic illustration showing a wireless sensing system 100 according to an embodiment of the invention. Referring to FIG. 1, the wireless sensing system 100 includes a sensing device 101, a transmission device 102, and a micro-processing device 103. The micro-processing device 103 is coupled to the sensing device 101 and the transmission device 102.

The sensing device 101 senses a physical quantity or a chemical quantity of peripheral environment of the wireless sensing system 100, and generates a sensing signal S according to the peripheral environment. The sensing device 101 transmits the sensing signal S to the micro-processing device 103. The transmission device 102 coupled to the micro-processing device 103 receives the sensing signal S, and performs data transmission with an external network through a radio-frequency signal RF. In one embodiment, the wireless sensing system 100 transmits the sensing signal S through the radio-frequency signal RF.

The wireless sensing system 100 makes the micro-processing device 103 perform the corresponding operations according to the sensing signal S and the radio-frequency signal RF.

Herein, it is to be noted that during the booting and initializing process of the wireless sensing system 100, the micro-processing device 103 sets a threshold value in the sensing device 101. After the wireless sensing system 100 is initialized, the micro-processing device 103 and the transmission device 102 are in a sleep state. When the physical quantity or the chemical quantity of the peripheral environment sensed by the sensing device 101 exceeds the threshold value, the sensing device 101 wakes up the micro-processing device 103 and the transmission device 102, and the micro-processing device 103 transmits the sensing signal S to the transmission device 102, so that the transmission device 102 transmits the sensing signal S through the radio-frequency signal RF. In one embodiment, the sensing signal S may include the physical quantity or the chemical quantity of the peripheral environment sensed by the sensing device 101.

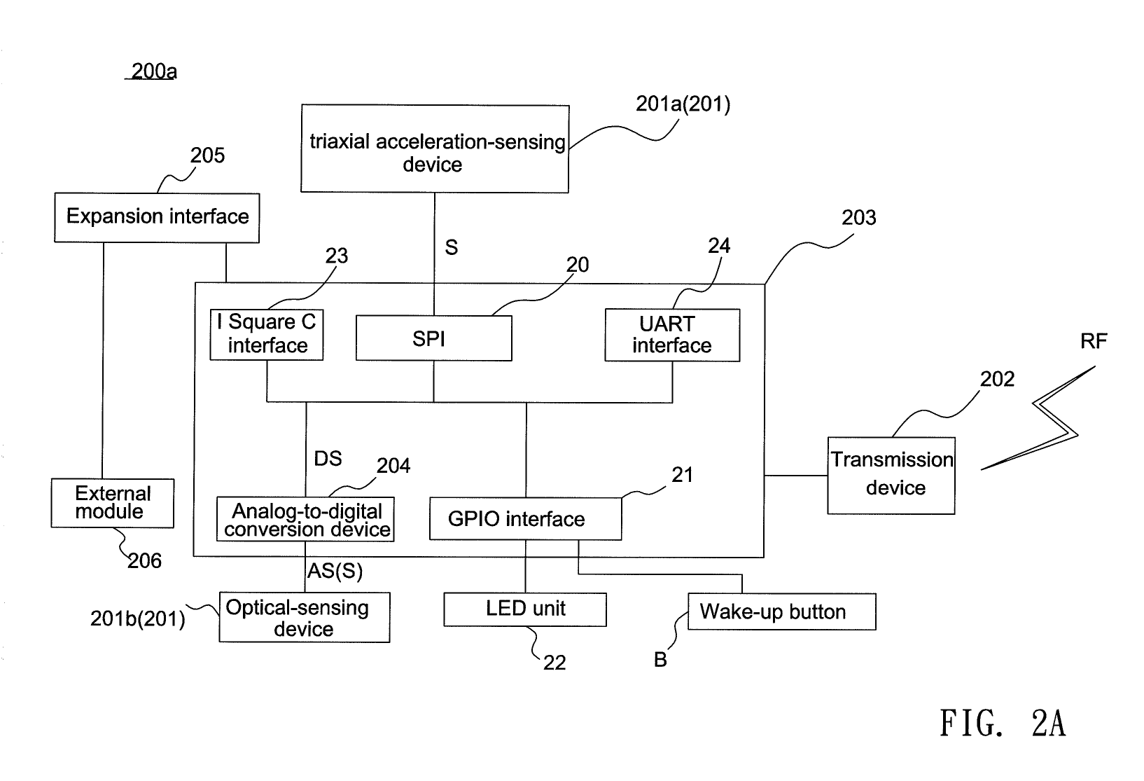

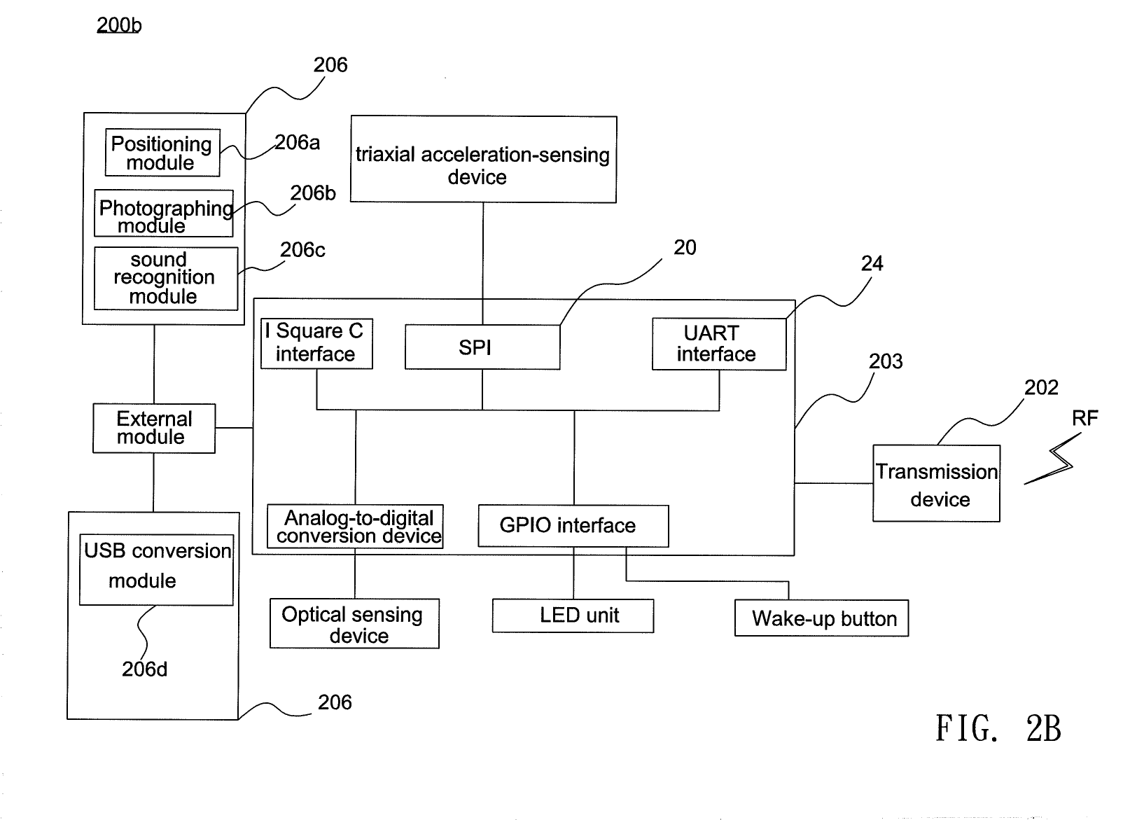

FIG. 2A is a schematic illustration showing a wireless sensing system 200a according to an embodiment of the invention. Referring to FIG. 2A, a sensing device 201 of the wireless sensing system 200a of this embodiment may be implemented by a triaxial acceleration-sensing device 201a, and the sensing signal S is an acceleration value. In one embodiment, the triaxial acceleration-sensing device 201a calculates the acceleration values corresponding to the X axis, the Y axis, and the Z axis according to the displacement per unit time. For example, when the user waves an object equipped with the wireless sensing system 200a, the wireless sensing system 200a is subjected to an external force and generates the displacement per unit time, and the triaxial acceleration-sensing device 201a can sense and calculate the acceleration values corresponding to the X axis, the Y axis, and the Z axis. In this embodiment, the triaxial acceleration-sensing device 201a is mainly used to detect the acceleration values generated when the human body is exercising or the environment is shaking.

It is to be noted that when the wireless sensing system 200a is booting and initializing, a micro-processing device 203 sets a threshold value in the triaxial acceleration-sensing device 201a. In one embodiment, the micro-processing device 203 may set the same threshold value or different threshold values with respect to the X axis, the Y axis, and the Z axis of the triaxial acceleration-sensing device 201a.

After the wireless sensing system 200a is initialized, the micro-processing device 203 and a transmission device 202 are in a sleep state. At this time, if the triaxial acceleration-sensing device 201a senses an acceleration value corresponding to one of the X, Y, and Z axes to be larger than the predetermined threshold value, the triaxial acceleration-sensing device 201a can wake up the micro-processing device 203 and the transmission device 202, so that the micro-processing device 203 and the transmission device 202 can perform the corresponding adjustments.

In one embodiment, the micro-processing device 203 transmits the acceleration values, corresponding to the X, Y, and Z axes, to the transmission device 202, so that the transmission device 202 transmits the acceleration values through the radio-frequency signal RF, and the triaxial acceleration-sensing device 201a transmits the sensed acceleration values through a transmission interface. In this embodiment, the transmission interface is implemented by a serial peripheral interface bus (SPI) 20.

In addition, when the micro-processing device 203 of this embodiment is setting the threshold values of the triaxial acceleration-sensing device 201a, it also sets the parameter of the triaxial acceleration-sensing device 201a concurrently, wherein the parameter may be a precision rate or a sampling rate of the triaxial acceleration-sensing device 201a.

In addition, the micro-processing device 203 further includes an analog-to-digital conversion device 204, and the sensing device 201 further includes an optical-sensing device 201b for measuring data of an environment light ray, an infrared ray, or the like.

The optical sensing device 201b coupled to the analog-to-digital conversion device 204 senses the light ray and transmits the sensing signal S, such as an analog signal AS in the form of voltages or currents, to the analog-to-digital conversion device 204, which converts the analog signal AS into a digital signal DS to be transmitted to the micro-processing device 203. In other words, after the wireless sensing system 200a is initialized, the analog-to-digital conversion device 204 and the optical sensing device 201b are in an awake state, and the optical sensing device 201b senses the environment light ray and transmits the analog signal AS to the analog-to-digital conversion device 204. Then, the analog-to-digital conversion device 204 converts the analog signal AS into the digital signal DS. If the luminance of the environment light ray exceeds the threshold value (i.e., the converted digital signal DS exceeds the threshold value set in the analog-to-digital conversion device 204), the analog-to-digital conversion device 204 transmits the digital signal DS to the micro-processing device 203, so that the micro-processing device 203 and the transmission device 202 are waken from the sleep state and perform the corresponding operations.

For example, when the wireless sensing system 200a is established in a wireless network system, due to the environmental factor of the environmental where the wireless sensing system 200a is established, the wireless sensing system 200a does not necessarily have the shaking condition. Consequently, the triaxial acceleration-sensing device 201a cannot sense the acceleration values corresponding to the X, Y, and Z axes. So, the optical sensing device 201 can detect the environment light and transmit the signal to the analog-to-digital conversion device to perform the threshold-value comparison and thus achieve the function, which is the same as that of the triaxial acceleration-sensing device 201a and is for waking up the wireless sensing system 200a.

Also, the micro-processing device 203 transmits the sensing signal S to a light-emitting diode (LED) unit 22 through a general-purpose input/output (GPIO) interface 21, so that the LED unit 22 generates the corresponding flickering operation. Thus, the user can understand the environment condition through the flickering operation of the LED unit.

Please note that the wireless sensing system 200a further includes a wake-up button B, and a user may press the wake-up button B to directly wake the micro-processing device 203 and the transmission device 202 up.

In this embodiment, the wireless sensing system 200a includes an expansion interface 205, and the micro-processing device 203 may perform the data transmission with an external module 206 through the expansion interface 205. The expansion interface 205 may perform the data transmission with the external module 206 through an I Squared C interface 23, a serial peripheral interface bus (SPI) 20, or a universal asynchronous receiver/transmitter (UART) interface 24.

FIG. 2B is a schematic illustration showing a wireless sensing system 200b according to an embodiment of the invention. Referring to FIG. 2B, the difference between the wireless sensing systems 200b and 200a resides in that the external module 206 of the wireless sensing system 200b further includes a positioning module 206a, a photographing module 206b, a sound recognition module 206c and a USB conversion module 206d. In this embodiment, the positioning module 206a, the photographing module 206b and the sound recognition module 206c perform the data transmission through the SPI 20, and the USB conversion module 206d performs the data transmission through the UART interface 24.

The positioning module 206a can transmit the current location coordinate information of the wireless sensing system 200b to the external network through the transmission device 202. The photographing module 206b can be used to take a photograph and transmit the image data through the transmission device 202. The sound recognition module 206c can recognize the sound within the predetermined range. In one embodiment, if the sound volume is larger than the predetermined threshold value, the micro-processing device 203 and the transmission device 202 may be woken up through the sound to perform the corresponding adjustment.

In addition, the USB conversion module 206d of this embodiment converts the data on the wireless sensing system 200b from the data for the UART interface 24 into the data for the USB interface. Consequently, the wireless sensing system 200b can directly utilize the USB transmission cable to transmit the data to the external network. In one embodiment, the USB conversion module 206d may be implemented by a CP210x chipset.

So, the wireless sensing system 200b can be expanded to have various functions of modules through the expansion interface 205 so that the functionality of the wireless sensing system 200b becomes more powerful.

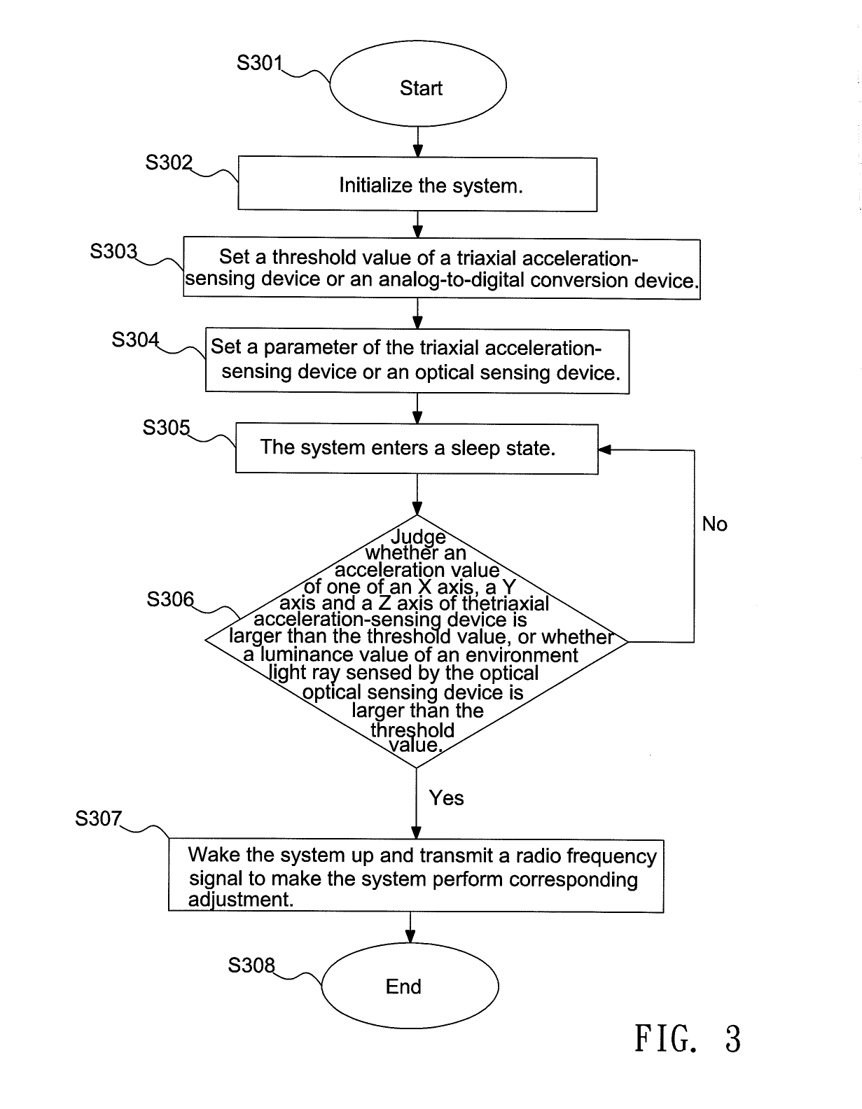

FIG. 3 is a flowchart showing an operation method of a wireless sensing system according to an embodiment of the invention. Referring to FIG. 3, the operation method includes the following steps.

In step S301, the method starts.

In step S302, the system is initialized.

In step S303, a threshold value of the triaxial acceleration-sensing device or the analog-to-digital conversion device is set.

In step S304, a parameter of the triaxial acceleration-sensing device or the optical-sensing device is set.

In step S305, the system is enabled to enter a sleep state.

In step S306, it is judged whether the acceleration value of one of the X, Y, and Z axes of the triaxial acceleration-sensing device is larger than the threshold value, or whether the luminance value of the environment light ray measured by the optical sensing device is larger than the threshold value. If yes, the procedure jumps to step S307; and if not, the procedure jumps to the step S305.

In the step S307, the system is woken up, and a radio-frequency signal is transmitted to make the system perform the corresponding adjustment.

In step S308, the method ends.

The parameter is the precision rate or the sampling rate of the triaxial acceleration-sensing device or the optical sensing device.

In summary, the wireless sensing system of the invention can utilize the triaxial acceleration-sensing device to detect the acceleration value corresponding to one of the X, Y, and Z axes, or utilize the optical sensing device to measure the luminance of the environment light ray. Thus, the wireless sensing system can determine whether to wake the system up to perform the data transmission by judging whether the acceleration value or the luminance is larger than the threshold value. If the acceleration value, which corresponds to one of the X, Y, and Z axes and is detected by the triaxial acceleration-sensing device, or the luminance measured by the optical-sensing device is not larger than the threshold value, the wireless sensing system may be in the sleep state to save the power.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A wireless sensing system, comprising:
a sensing device sensing a physical quantity or a chemical quantity of peripheral environment and generating a sensing signal;
a transmission device, which is coupled to the sensing device and performs data transmission with an external network through a radio-frequency signal; and
a micro-processing device generating a corresponding operation according to the sensing signal or the radio-frequency signal, wherein:
after the system is initialized, the micro-processing device and the transmission device are in a sleep state; and
when the sensing signal is larger than a threshold value, the sensing device wakes the micro-processing device and the transmission device up.

2. The system according to claim 1, wherein the sensing device is a triaxial acceleration-sensing device, the sensing signal is an acceleration value of one of an X axis, a Y axis, and a Z axis of the sensing device, and the acceleration value is transmitted through a transmission interface.

3. The system according to claim 1, wherein: the micro-processing device comprises an analog-to-digital conversion device, the sensing device comprises an optical sensing device, and the sensing signal is an analog signal; and after the system is initialized, the analog-to-digital conversion device is in an awake state.

4. The system according to claim 3, wherein:
the optical-sensing device senses an environment light ray of the peripheral environment, and transmits the analog signal to the analog-to-digital conversion device;
the analog-to-digital conversion device converts the analog signal into a digital signal; and
if light ray luminance of the environment light ray exceeds the threshold value set in the analog-to-digital conversion device, the analog-to-digital conversion device wakes up the micro-processing device and the transmission device to perform the corresponding operation.

5. The system according to claim 1, wherein the micro-processing device transmits the sensing signal to a light-emitting diode (LED) unit through a general-purpose input/output (GPIO) interface, and the light-emitting diode (LED) unit generates a corresponding flickering operation.

6. The system according to claim 5, further comprising a wake-up button, wherein a user may wake up the micro-processing device and the transmission device by pressing the wake-up button.

7. The system according to claim 2, further comprising an expansion interface, wherein the micro-processing device may perform data transmission with an external module through the expansion interface.

8. The system according to claim 7, wherein the expansion interface performs the data transmission with the external module through an I Squared C interface, a serial peripheral interface (SPI) or a universal asynchronous receiver/transmitter (UART) interface, and the transmission interface is the SPI.

9. A method of operating a wireless sensing system, the method comprising:
initializing the system;
setting a threshold value of a triaxial acceleration-sensing device or an analog-to-digital conversion device;
setting a parameter of the triaxial acceleration-sensing device or an optical-sensing device;
letting the system enter a sleep state; and
judging whether an acceleration value of one of an X axis, a Y axis, and a Z axis of the triaxial acceleration-sensing device is larger than the threshold value, or whether a luminance value of an environment light ray sensed by the optical-sensing device is larger than the threshold value, and waking the system up and transmitting a radio-frequency signal to make the system perform corresponding adjustment when the acceleration value or the luminance value is larger than the threshold value.

10. The method according to claim 9, wherein the parameter is a precision rate or a sampling rate of the triaxial acceleration-sensing device or the optical-sensing device.
